(19) United States
(12) Patent Application Publication
(10) Pub. No.: US 2022/0188530 A1
(43) Pub. Date: Jun. 16, 2022

(54) ELECTRONIC TAG WRITING SYSTEM AND METHOD FOR SAME

(71) Applicants: DAIO PAPER CORPORATION, Shikokuchuo-shi, Ehime (JP); DAIO ENGINEERING CO., LTD., Shikokucuo-shi, Ehime (JP)

(72) Inventors: Taro IKAWA, Tokyo (JP); Koki BEPPU, Odawara-shi (JP); Hirohide OUCHI, Odawara-shi (JP); Eiji NISHYAMA, Odawara-shi (JP); Ryoto TAKAHASHI, Odawara-shi, (JP); Shin KOYAMA, Odawara-shi (JP); Shuntaro NOGUCHI, Odawara-shi (JP)

(73) Assignees: DAIO PAPER CORPORATION, Shikokuchuo-shi, Ehime (JP); DAIO ENGINEERING CO., LTD., Shikokucuo-shi, Ehime (JP)

(21) Appl. No.: 17/436,764

(22) PCT Filed: Feb. 19, 2020
(86) PCT No.: PCT/JP2020/006478

§ 371 Date: Sep. 7, 2021

(30) Foreign Application Priority Data
Mar. 11, 2019 (JP) 2019-044001

(51) Int. Cl. G06K 7/10

(52) U.S. Cl. CPC G06K 7/10366

(57) ABSTRACT

A technology for writing information that varies by object into electronic tags. An electronic tag writing system that includes a writing device that writes writing information into electronic tags; and an information acquisition part that reads writing information and a processing order out of a storage part that stores the processing order in association with writing information for objects that are associated with the electronic tags. The writing information that is associated with the processing order acquired by the information acquisition part is written into the electronic tags by the writing device in accordance with the processing order.

### TECHNICAL FIELD

The present invention relates to an electronic tag writing system and a method for the same.

### BACKGROUND ART

As is well known, an electronic tag (also referred to as an RF tag, an IC tag, an RF label, or the like) includes an IC chip and an antenna connected to the IC chip for performing storage and reading-out of information in a non-contact manner by near field communication. In addition, typically, the electronic tag has an adhesive surface as a rear surface for sticking to objects, or the electronic tag is applied to a product with a string or the like without the adhesive surface. Radio frequency identification (RFID) is an automatic recognition system that performs wiring of information relating to the objects to the electronic tag and reading-out of information stored in the electronic tag through radio communication by using the electronic tag.

Various examinations and suggestions have been made on the electronic tag, and some are realized and some are not realized. For example, the electronic tag is expected to be applied to individual product management of products as an alternative to an optically readable tag such as a barcode, but use in a retail business such as a convenience storage in which a unit price is low is not realized in Japan. The main reason for this is that a unit price of the electronic tag is high, but a reading accuracy related problem (blocking of radio waves due to water contained in the content of the product, a metallic product container, or the like), incompletion of a technology of writing the electronic tag to individual products, and the like also become a hindrance to spreading.

Of these, with regard to the electronic tag writing technology, there is suggested a technology of writing constant information (for example, manufacturing information, track loading information, inventory information, sale information, loss information, delivery information, consumption expiration date information, and consumption information) to an electronic tag with respect to constant products (for example, refer to Patent Document 1 to Patent Document 4).

However, in order to realize individual product management of products by using a method of attaching the electronic tag to which the constant information is written to the products, source tagging (attachment of the electronic tag to the products by a manufacturer) is necessary for almost all products, and thus it takes a lot of time for improvement of an environment thereof.

In addition, even though the improvement is possible, a retail store cannot correspond to requirement for attachment of electronic tags to which information different for every object is written. That is, in a case where the retail store attaches the electronic tag, it is necessary to attach an electronic tag to which individually different information is written to products of which a type (a size, packaging, or the like), a quantity, and the like are different (small-quantity and many-kinds), but it is not realistic to manually carry out the attachment and, currently, a device that automatically carries out the attachment is also not provided. Of course, it is needless to say that the same requirement as in the retail store is present in manufacturers of small-quantity and many-kinds or the like other than the retail store.

### CITATION LIST

### Patent Document

Patent Document 1: JP-A-2005-104521
Patent Document 2: JP-A-2007-091246
Patent Document 3: JP-A-2007-091298
Patent Document 4: JP-A-2008-044661
Patent Document 5: JP-A-2008-62965

### SUMMARY OF THE INVENTION

### Technical Problem

Here, a main object of the invention is to provide a technology of writing information different in correspondence with an object to an electronic tag.

### Solution to Problem

An electronic tag writing system and a method for the same which accomplished the object are as follows.

<First Aspect>

An electronic tag writing system including:

a writing device that writes writing information to an electronic tag; and

an information acquisition unit that reads out the writing information and a processing order from a storage unit that stores the writing information and the processing order in association with each other, the writing information and the processing order relating to objects associated with the electronic tag,

in which the writing information associated with the processing order is written to the electronic tag by the writing device in accordance with the processing order acquired by the information acquisition unit.

### Operational Effect

In this electronic tag writing system, since the writing information relating to the objects associated with the electronic tag is acquired, and writing is performed with respect to a corresponding electronic tag, information that is different in correspondence with an object can be written to the electronic tag. For example, in the case of sticking the electronic tag at a retail store, when attaching the electronic tag to received products of which a type (a size, packaging, or the like), a quantity, and the like are different (small-quantity and many-kinds), information that is different in correspondence with each of the objects can be written to the electronic tag.

In addition, since the writing information associated with the processing order is written to the electronic tag in accordance with the processing order read out from the storage unit, in the case of attaching an electronic tag with respect to a plurality of kinds of objects to be processed (handled) in a determined order, information that is different in correspondence with each of the objects can be automatically written.

<Second Aspect>

The electronic tag writing system according to the first aspect,

in which in a production and distribution process of the objects, the processing order of the objects in the process and the writing information of each of the objects are stored in the storage unit.

### Operational Effect

In the production and distribution process of the objects, since the processing order of the objects and the writing information of each of the objects are determined, the processing order of the objects and the writing information of each of the objects are preferably stored in the storage unit in accordance with the determined processing order and writing information.

<Third Aspect>

The electronic tag writing system according to the first or second aspect, further including:

a tag supply unit that sequentially supplies the electronic tag to the writing device,

in which in a first process in the production and distribution of the objects, the processing order of the objects in the process, and the writing information of each of the objects are acquired and are stored in the storage unit, and

in a second process of processing the objects in the processing order downstream of the first process, the writing information associated with the processing order is sequentially written to the electronic tag by the writing device in accordance with the processing order.

### Operational Effect

In this system, for example, in the first process of processing (handling) the objects in a constant order as in a transfer process and an inspection process of the objects in production facility of the objects, a transportation process in distribution of the objects, and the like, the processing order and the writing information of the objects are stored in the storage unit in advance, and then in the second process of processing the objects in the processing order, writing to the electronic tag is sequentially performed in accordance with the processing order. Accordingly, the electronic tag after the writing is sequentially attached to the object, and thus an electronic tag to which information different in correspondence with each of the objects is written can be automatically attached to the objects.

<Fourth Aspect>

The electronic tag writing system according to the first or second aspect, further including:

a tag supply unit that sequentially supplies the electronic tag; and

a tag attachment unit that attaches the electronic tag supplied from the tag supply unit to the object,

in which in a first process in the production and distribution of the objects, the processing order of the objects in the process, and the writing information of each of the objects are acquired and are stored in the storage unit,

in a second process in the production and distribution of the objects, the electronic tag is attached to the objects by the tag attachment unit, and

in a third process of processing the objects in the processing order downstream of the first process and the second process, the writing information associated with the processing order is sequentially written to the electronic tag attached to the objects by the writing device in accordance with the processing order.

### Operational Effect

In this system, for example, in the first process of processing (handling) the objects in a constant order as in a transfer process and an inspection process of the objects in production facility of the objects, a transportation process in distribution of the objects, and the like, the processing order and the writing information of the object are stored in the storage unit in advance. In addition, in the second process that is performed simultaneously with or before or after the first process, the electronic tag is attached to the objects. Then, in the third process of processing the objects in the processing order, writing to the electronic tag attached to the objects is sequentially performed in accordance with the processing order. Accordingly, the electronic tag to which information different in correspondence with each of the objects is written can be automatically attached to the objects.

More specifically, when transporting products of which a type (a size, packaging, or the like), a quantity, and the like are different (small-quantity and many-kinds) from a distribution center to a product delivery destination such as a retail store, it is possible to realize an aspect in which storage of the processing order and the writing information with respect to the storage unit and attachment of the electronic tag are performed at the distribution center, and writing to the electronic tag is performed in the product delivery destination. Note that, in the tag attachment unit, in addition to attachment of the electronic tag and writing to the electronic tag for every object, after attaching the electronic tag to all objects which are processed at a time, writing to the electronic tag attached to each of the objects can also be sequentially performed.

<Fifth Aspect>

The electronic tag writing system according to the first or second aspect,

in which a supply unit of the electronic tag and an attachment unit of the electronic tag are not provided, and

in a process of processing the objects in the processing order in the production and distribution of the objects, the writing information associated with the processing order is written to the electronic tag attached to the objects by the writing device in accordance with the processing order acquired by the information acquisition unit.

### Operational Effect

This electronic tag writing system is a system in which only the writing information is written to the electronic tag without supplying the electronic tag to be attached to the objects. More specifically, when transporting products of which a type (a size, packaging, or the like), a quantity, and the like are different (small-quantity and many-kinds) from a producer to a retail store or the like, the producer ships a product in a state where an unwritten electronic tag is attached to the product, or a container or a package of the product, and at a retail store or a distribution center of the product, information different in correspondence with each of objects can be automatically written in a process of handling the product in a determined order.

<Sixth Aspect>

A method of writing an electronic tag, including:

a step of reading out writing information and a processing order from a storage unit that stores the writing information and the processing order in association with each other, the writing information and the processing order relating to objects associated with the electronic tag; and

a step of writing the writing information associated with the processing order to the electronic tag in accordance with the read-out processing order.

### Operational Effect

The same operational effect as in the first aspect is obtained.

### Advantageous Effects of the Invention

According to the invention, there is an advantage that information different in correspondence with an object can be written to an electronic tag.

### BRIEF DESCRIPTION OF THE DRAWINGS

FIG. 1 is a schematic view of an electronic tag writing system.

FIG. 2 is a schematic view of the electronic tag writing system.

FIG. 3 is a schematic view of the electronic tag writing system.

FIG. 4 is a schematic view of the electronic tag writing system.

FIG. 5 is a schematic view of the electronic tag writing system.

FIG. 6 is a schematic view of the electronic tag writing system.

FIG. 7 is a schematic view of the electronic tag writing system.

FIG. 8 is a configuration diagram of a control unit.

FIG. 9 illustrates an example of an electronic tag, (a) is a plan view, (b) is a side view, (c) is a bottom view, (d) is a plan view, (e) is a side view, and (f) is a bottom view.

FIG. 10 is a perspective view illustrating an object to which the electronic tag is stuck.

FIG. 11 is a front view schematically illustrating the electronic tag writing system.

FIG. 12 is a side view schematically illustrating the electronic tag writing system.

FIG. 13 is a front view illustrating an example of a tag supply unit.

FIG. 14 is a front view illustrating an electronic tag transfer unit.

FIG. 15 is a front view schematically illustrating a main part of the electronic tag writing system.

FIG. 16 is a front view schematically illustrating a main part of the electronic tag writing system.

FIG. 17 is a front view schematically illustrating a main part of the electronic tag writing system.

FIG. 18 is a front view schematically illustrating a main part of the electronic tag writing system.

FIG. 19 is a front view schematically illustrating a main part of the electronic tag writing system.

FIG. 20 is a side view schematically illustrating the electronic tag writing system.

FIG. 21 is a side view schematically illustrating the electronic tag writing system.

FIG. 22 is a front view schematically illustrating an example of the tag supply unit.

FIG. 23 is a front view schematically illustrating a main part of the electronic tag writing system.

FIG. 24 is a flowchart illustrating one example of control.

### MODE FOR CARRYING OUT THE INVENTION

<Basic Matters>

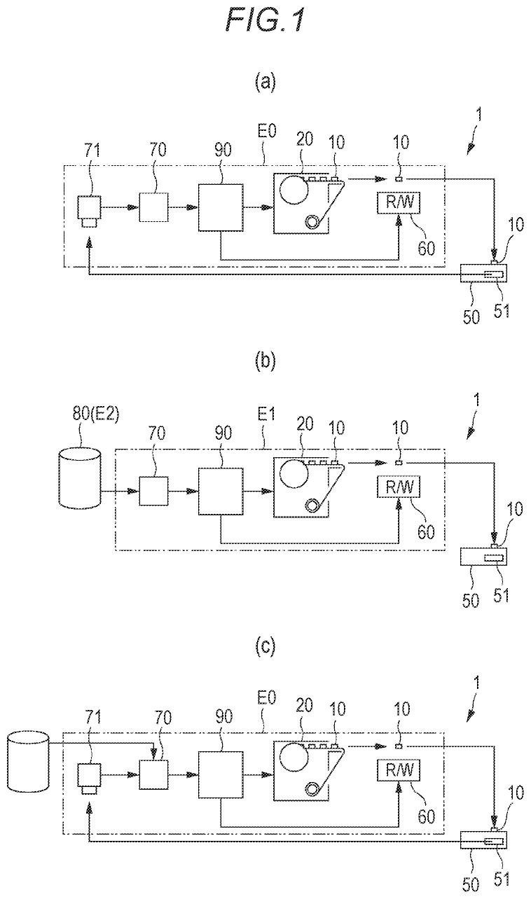

FIG. 1 to FIG. 7 illustrate a representative example of an electronic tag writing system 1. The electronic tag writing system 1 includes a writing device 60 that writes writing information to an electronic tag 10, an information acquisition unit 70 that acquires writing information relating to objects 50 associated with the electronic tag 10, and a control unit that writes the writing information acquired by the information acquisition unit 70 to the corresponding electronic tag 10 by the writing device 60.

Accordingly, in the electronic tag writing system 1, since the writing information relating to the objects 50 associated with the electronic tag 10 is acquired, and is written to the corresponding electronic tag 10, information different in correspondence with each of the objects 50 can be written to the electronic tag 10. For example, in the case of sticking the electronic tag 10 at a retail store, when attaching the electronic tag 10 to received products of which a type (a size, packaging, or the like), a quantity, and the like are different (small-quantity and many-kinds), information that is different in correspondence with each of the objects 50 can be written to the electronic tag 10.

(Control Unit)

The control unit 90 is configured to perform communication with constituent elements of a system while performing input and output or operation of information as necessary, and to control the constituent elements so as to operate the system. Accordingly, the control unit can be set to include an input and output device, an operation device, a communication device, a storage device, and the like. The control unit 90 can be configured by using a known industrial control device such as a sequencer (PLC) and a computer (PC, a microcontroller) alone, or by combining a plurality of the control devices in correspondence with a function or the like. For example, in the case of an application example to be described later, basic control and an interface of a conveyor, a sensor, a robot, or the like are realized by the sequencer, information processing or a command (instruction for mode setting, parameter setting, and operation initiation, and the like) with respect to the sequencer based on the information processing can be realized by the computer.

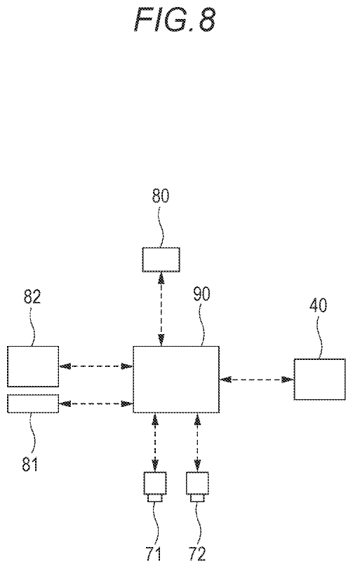

As illustrated in FIG. 8, the control unit 90 includes an input device 81 with which a worker performs input, and can perform various operations (information acquisition, writing, and the like) of the system in correspondence with the input. The input device 81 can be set as a keyboard, a mouse, or a dedicated switch. It is preferable that a display device 82 configured to display a graphical user interface such as a button for execution of processing is provided in order for the worker to select processing. In this case, it is particularly preferable that a touch panel including the input device 81 and the display device 82 integrated with each other is provided, and a selection input for processing is performed by touching a button for execution of continuous processing displayed on the display device 82. In addition, although not illustrated in the drawing, a portable terminal such as a smartphone including the display device 82 and the input device 81 can be connected to the control unit 90 through a network, near field communication, or wired communication, and processing may be selected by using the display device 82 and the input device 81 of the portable terminal.

(Electronic Tag)

A shape and a structure of the electronic tag 10 are not particularly limited as long as the electronic tag 10 is attached to an object, and a known electronic tag 10 can be appropriately used. For example, in addition to a price tag, a tag, or the like which is externally applied to the object, the electronic tag 10 may be embedded in a container, a lid, a packaging box, or a corrugated cardboard box for transportation of the object. The electronic tag 10 that is externally applied to the objects may be fixed or connected to the objects by an adhesive surface, a cable, a tag pin, or the like, but may be freely moved without being fixed or connected to the objects as long as the electronic tag 10 can be processed (handled) in combination with the objects.

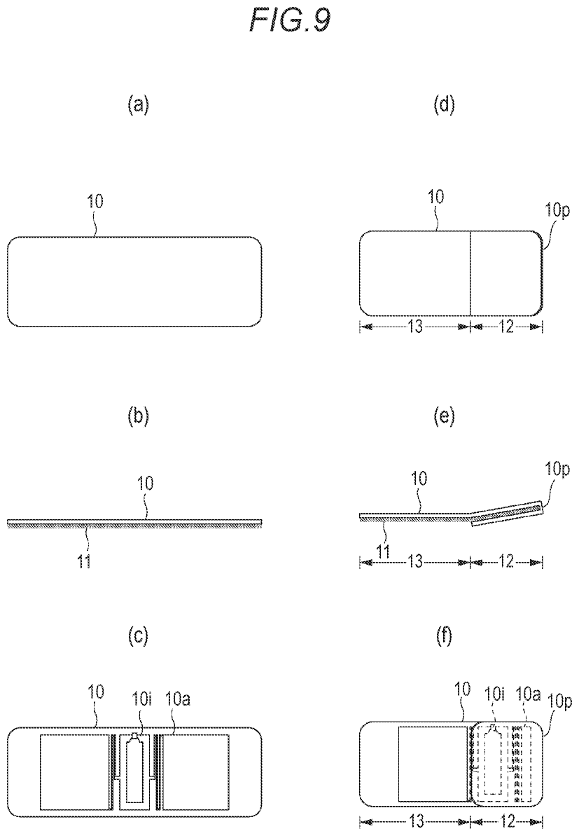

For example, a shape of the electronic tag 10 having the adhesive surface is, typically, a rectangular shape having corners as illustrated in examples illustrated in FIGS. 9(a) to 9(c), or examples illustrated in FIGS. 9(d) to 9(f), but the shape is not limited thereto. In addition, a representative one of the electronic tag 10 is a passive type electronic tag 10 including an IC chip 10i as inlets 10a and 10i and an antenna 10a connected thereto, for example, as illustrated in FIGS. 9(c) and 9(f), but there is not limitation thereto.

In the electronic tag 10, it is preferable that at least apart of the antenna 10a is spaced apart from sticking objects 50 so as to prevent deterioration of communication quality. Therefore, in the case of the electronic tag 10 having an adhesive surface 11, as illustrated in FIGS. 9(d) to 9(f), a part of the electronic tag 10 which includes the antenna 10a is folded at a folding position 10p to form a non-adhesive portion 12 in which parts of the adhesive surface 11 are stacked, and a residual adhesive portion 13 in which the adhesive surface 11 is exposed, and the electronic tag 10 can be stuck to the objects 50 with the adhesive surface 11 in the residual adhesive portion 13. Folding of the electronic tag 10 may be performed by a mechanism inside a tag supply unit 20 in a case where the tag supply unit 20 is provided as to be described later (for example, refer to Patent Document 5), and the electronic tag 10 of which apart is folded in advance may be supplied to this electronic tag writing system 1.

(Writing Information)

The writing information for the electronic tag 10 is information relating to the objects 50 associated with the electronic tag 10, and includes information different in correspondence with each of the objects 50. The writing information is not particularly limited thereto, but it is preferable that writing information includes a part or the entirety of individual information 51 of the objects 50. The individual information 51 includes both identification information for identifying the objects 50 from another object and attribute information representing characteristics, properties, or the like of the objects 50 although the objects 50 cannot be identified from the other object. Examples of the identification information include a product code, a serial number, a product number, and a lot number. In addition, examples of the attribute information include a color of a product or packaging, a product weight, and the like in addition to information other than a trademark such as a shipping order, a manufacturing date, a consumption expiration date, and a product name. In addition, the writing information may include accessary information other than the identification information and the attribute information. Examples of the accessary information include time information of time or the like necessary for manufacturing, temperature information of a temperature or the like at the time of manufacturing, humidity information of humidity at the time of manufacturing, random number information relating to fortune telling and lottery.

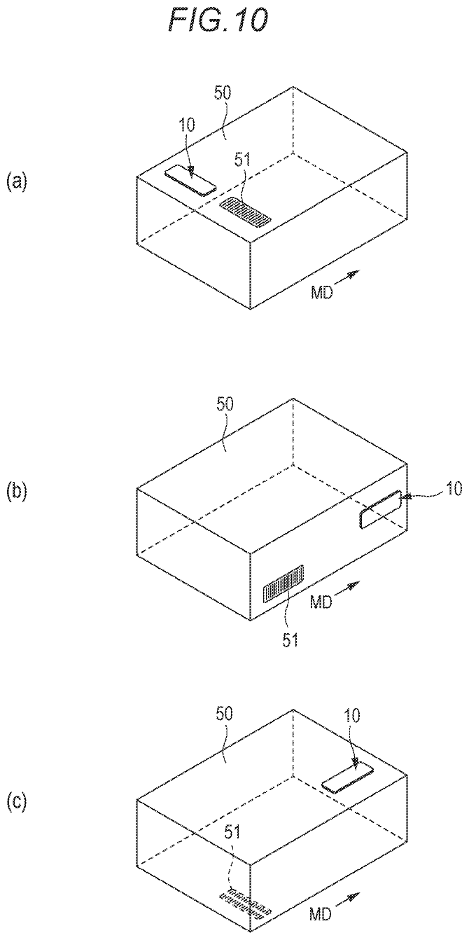

It is preferable that the individual information 51 or the attribute information is applied to the objects 50 as a one-dimensional code or a two-dimensional code, or as characters, figures, or the like as is through printing or the like as illustrated in FIG. 10 because the individual information 51 or attribute information of the objects 50 can be easily acquired from the objects 50, but there is no limitation thereto.

(Information Acquisition Unit)

The information acquisition unit 70 can set a part or the entirety of the writing information as primary information capable of being acquired from the objects 50. According to this, preparation of the writing information becomes more accurate and easier. For example, the information acquisition unit 70 can include an individual information sensor 71 that detects individual information 51 from the objects 50.

The individual information sensor 71 is not particularly limited as long as the individual information sensor 71 can detect the individual information 51 from the objects 50. For example, the individual information sensor 71 can be set as at least one of a code reader, an optical character reading device, a color sensor, a weight sensor, a magnetic sensor, a voice recognition sensor, and the like. In a case where the individual information sensor 71 is a code reader of a one-dimensional code or a two-dimensional code, the electronic tag 10 to which the read-out information is written can be attached to the objects 50. Accordingly, for example, if a retailer attaches the electronic tag 10 to a product for sale, the retailer can collectively identify a number of products at a time in a non-contact manner in a registration, inspection, and inventory operation, shoplifting prevention by using a security gate, and the like. In addition, in a case where the individual information sensor 71 is the optical character reading device, the individual information sensor 71 reads marks such as a product size, a product color, the content, a manufacturing date, or a consumption expiration date applied to the objects 50 (typically, a product exterior packaging or the product itself), and the electronic tag 10 to which the read-out information is written can be attached to the objects 50. In addition, in a case where the individual information sensor 71 is the color sensor, the electronic tag 10 to which information relating to the color of the objects 50 is written can be attached to the objects 50, and in a case where the individual information sensor 71 is the weight sensor, the electronic tag 10 to which information relating to the weight of the objects 50 is written can be attached to the objects 50. Accordingly, for example, if the retailer attaches the electronic tag 10 to products for sale, product management can be performed on the basis of the individual information 51 that is not included in a typically applied one-dimensional code or two-dimensional code.

In a case where the individual information sensor 71 is the magnetic sensor, the individual information sensor 71 reads magnetic recording information of an object with a magnetic stripe such as a ticket, a check (MICR), a passbook, and a credit card, and the electronic tag 10 to which the read-out information is written can be attached to the objects 50.

In a case where the individual information sensor 71 is the voice recognition sensor including a microphone and a voice recognition system, a worker recognizes individual information by visually recognizing individual information of the object with eyes, and speaking, and the electronic tag 10 to which the recognized information is written can be attached to the objects 50.

It is preferable that a detection target by the individual information sensor 71 include at least identification information, and more preferably both the identification information and the attribute information.

The code reader, the optical character reading device, and the color sensor are preferably realized by using an imaging sensor (image sensor) such as a CCD image sensor and a CMOS image sensor. In a method using the imaging sensor, a wide range of detection is possible, and utilization is possible as a multi-purpose reader that detects a plurality of kinds of detection targets. That is, in this case, a one-dimensional code or two-dimensional code, a character, and a color can be detected with one sensor without forming a sensor for each detection target. Of course, the individual information sensor 71 is not limited to the image sensor, and for example, various known sensors such as a laser scan type can be used in the case of the code reader.

It is preferable that the individual information sensor 71 is installed in a conveyor that is used in a process of production or distribution of the objects 50, or a conveyor equipped with the individual information sensor 71 is added, and the individual information 51 is detected from the objects 50 in conveyance by the conveyor.

In a case where the individual information sensor 71 is set as a handy type device (handy type code reader or the like), at the time of carrying-in, carrying-out, displaying, or the like of the objects 50, a worker can sequentially detect the individual information 51 of the plurality of objects 50 by holding the individual information sensor 71 by hands over each of the objects 50. In addition, in a case where the individual information sensor 71 is set as a stationary type device, and carrying-in, carrying-out, displaying, or the like of the objects 50 is performed, the worker can sequentially detect the individual information 51 of the plurality of objects 50 by holding each of the objects 50 by hands over the stationary type individual information sensor 71.

In a case where the information acquisition unit 70 includes the individual information sensor 71, the information acquisition unit 70 can be constituted by a computer (PC, a microcontroller, a tablet terminal, or a smartphone) provided with the individual information sensor 71 such as a digital still camera and a microphone.

(Storage Unit)

The information acquisition unit 70 can read out the writing information from a storage unit 80 that stores the writing information and the like instead of acquiring the entirety of the writing information from the objects 50. In addition, the information acquisition unit 70 can acquire a part of the writing information from the objects 50, and can read out the remainder from the storage unit 80.

The storage unit 80 can be set as a network access storage, a cloud storage, the other storage servers, or a database server that is connected through a local network or the Internet in addition to a storage device such as a hard disk and an SSD which are embedded in the control unit 90 or are externally attached. The storage unit 80 may be a storage unit 80 of a distribution system such as a POS system, a production management system, or the like, or may store information copied from the information of the storage unit 80 of the systems, or information obtained by performing change or addition to the information. In this case, in a process of production and distribution of the objects 50, the processing order of the objects 50 in the process, and writing information of each of the objects 50 are stored in the storage unit 80. In addition, in a process of production and distribution of the objects 50, on the basis of at least one of apart or the entirety of primary information acquired by the individual information sensor 71 or the like, and secondary information acquired on the basis of the acquired primary information, the processing order of the objects 50 in the process and the writing information of each of the objects 50 can also be stored in the storage unit 80.

In a case where a plurality of kinds of information are stored, in addition to a configuration in which the storage unit 80 is installed for every kind, a single storage unit 80 that stores all kinds of information may also be installed. For example, in the case of an application example to be described later, it is assumed that the writing information and sticking position information are stored in a single storage unit 80 in an illustrated example, but there is no limitation thereto.

In a case where the information acquisition unit 70 reads out the writing information from the storage unit 80, the information acquisition unit 70 can be constituted by a computer (PC, a microcontroller, a tablet terminal, or a smartphone), and can include an input device such as a mouse, a keyboard, and a touch panel (that is, can be configured as in the control unit 90).

The storage unit 80 stores identification information of the objects 50 and the writing information associated with the identification information, and the information acquisition unit 70 may read out the writing information from the storage unit 80 on the basis of identification information read out by the individual information sensor 71, or on the basis of identification information input by the input device 81 such as a mouse, a keyboard, and touch panel. That is, the writing information may include the secondary information acquired on the basis of the primary information acquired from the objects 50. For example, in the case of the electronic tag 10 to be stuck to products, the identification information such as the above-described one-dimensional code is detected by the individual information sensor 71, and the control unit 90 acquires attribute information from the storage unit 80 that stores the identification information and the attribute information such as a product name and a consumption expiration date in association with each other on the basis of the detection result, and can write only the acquired attribute information or both the attribute information and the identification information to the electronic tag 10 as the writing information.

In addition, in a case where the information acquisition unit 70 reads out the writing information from the storage unit 80, the information acquisition unit 70 may select one or a plurality of pieces of writing information from the storage unit 80 by an input device or the like, and may read out the writing information one by one or may continuously read out the plurality of pieces of writing information.

Particularly, in the case of continuously reading out the writing information, when the writing information and the processing order of the object 50 are stored in the storage unit 80 in association with each other, the information acquisition unit 70 reads out the writing information associated with the processing order from the storage unit 80 in accordance with the processing order, and the read-out writing information can be written to the electronic tag 10 by the writing device 60.

(Writing Device)

The writing device 60 is a device (so-called reader/writer) capable of performing writing to the electronic tag 10, and an installation position thereof can be appropriately determined. For example, in the case of performing writing to the electronic tag 10 from a constant distance, the writing device 60 may be installed in a fixed manner in a movement route of the electronic tag 10, and can sequentially perform writing to the electronic tag 10 in movement or in temporarily stoppage. In this case, the electronic tag 10 may be in a state of being attached to the objects 50 or in a state of not being attached to the objects 50. In the former case, for example, the writing device 60 can be installed in a conveyor that conveys the objects 50. In the latter case, for example, the writing device 60 can be installed in the tag supply unit 20.

In the case of performing writing by bringing the writing device 60 close to the electronic tag 10, the writing device 60 is set as a handy type device (handy type code reader or the like), and at the time of carrying-in, carrying-out, displaying, or the like of the objects 50, a worker can sequentially perform writing with respect to a plurality of the electronic tag 10 by holding the writing device 60 by hands over each of the electronic tags 10. The writing device 60 may be installed in a robot 40, and writing can also be performed by controlling the robot 40 to bring the writing device 60 close to the electronic tag 10.

In addition, in a case where the writing device 60 is set as a stationary type device, at the time of carrying-in, carrying-out, displaying, or the like of the objects 50, a worker can also sequentially perform writing with respect to a plurality of the electronic tags 10 by holding the objects 50 by hands over the stationary type writing device 60.

The writing process by the writing device 60 can employ a known method without particular limitation.

(Tag Attachment Unit)

A tag attachment unit can be disposed to attach the electronic tag 10 to the objects 50 by the electronic tag writing system 1. In the case of the electronic tag 10 having the adhesive surface 11, as the tag attachment unit, the robot 40 in the application example to be described later, or other known sticking devices (labeler) can be employed. The tag attachment unit may be a handy type sticking device (handy labeler) that is held by a worker and is pressed against the objects 50 to stick the electronic tag 10. In the case of the electronic tag 10 that does not have the adhesive surface 11, the tag attachment unit may be a tagging device that attaches the electronic tag 10 to the objects 50 such as clothes through a cable, a tag pin, or the like, or may be an insertion device that inserts the electronic tag 10 into a packaging box of products.

(Robot)

The robot 40 may have two or more degrees of freedom capable of performing at least movement in a horizontal direction and movement in a vertical direction, but a robot 40 having four or more degrees of freedom capable of performing movement in an X-axis direction, a Y-axis direction, a Z-axis direction, and movement in a rotational direction around the Z-axis is preferable so as to cope with a case where positions of the objects 50 on a conveyor 30 are irregular. According to this, as illustrated in FIGS. 10(a) and 10(c), the electronic tag 10 can be stuck to an upper surface of the objects 50 in all directions. In addition, when using a robot 40 having six or more degrees of freedom, the electronic tag 10 can be stuck to not only the upper surface of the objects 50 but also a side surface thereof as illustrated in FIG. 10(b). Accordingly, the electronic tag 10 can be stuck to a position that is less likely to have an influence on products or a position that is less likely to deteriorate communication quality in correspondence with the objects 50. As the robot 40, not only a parallel link robot as in an illustrated example, but also a known industrial robot such as a vertical articulated robot, a horizontal articulated robot, and an orthogonal robot can be used.

(Tag Supply Unit)

The tag supply unit 20 may be disposed so as to supply the electronic tag 10 into the electronic tag writing system 1. The tag supply unit 20 is configured to sequentially supply the electronic tag 10 to the writing device 60 or the tag attachment unit, and to an extent thereof, known all supply mechanism (for example, supply mechanisms described in Patent Document 1 to Patent Document 5, or the like) can be employed. For example, in the case of supplying an electronic tag 10 having the adhesive surface 11, the tag supply unit 20 that sequentially peels off the electronic tag 10 from a strip-shaped release sheet 16 to which the electronic tag 10 is repetitively stuck, and supplies the electronic tag 10 can be used. In the case of supplying an electronic tag 10 that does not have the adhesive surface 11, a tag supply unit 20 that sequentially forms and supplies the electronic tag 10 by cutting or punching a strip-shaped material in which a unit portion to be the electronic tag 10 is repeatedly continuous at a boundary of each unit portion can be used. The tag supply unit 20 may be built in a device of the tag attachment unit.

(Device Configuration)

In the electronic tag writing system 1, the entirety of constituent elements may be integrated as one device, or a system in which a plurality of devices constituted by one or a plurality of constituent elements are combined may be employed. Particularly, as in constituent elements such as the information acquisition unit 70, the control unit 90, and the storage unit 80, it is preferable that in constituent elements which can be constructed as a combination of hardware or software on one device, some or all of the constituent elements are constructed on one device. In addition, unidirectional or bidirectional communication (including communication through a network in addition to communication without through a network) can be established for some or all of the constituent elements in a wired or wireless manner so as to cooperate as a system. In addition, some of the constituent elements may operate independently from the other constituent elements.

The electronic tag writing system 1 may be a handy type device as a whole, or may be a stationary type device to a certain extent capable of being installed on a desk or to a certain extent of a register in a retail store. In addition, as in an application example to be described later, a large device including a conveyor or a robot 40 is also possible. In addition, in a case where the electronic tag writing system 1 is constituted by a plurality of devices, each of the devices may be a handy type device, may be a stationary type device to a certain extent capable of being installed on a desk or to a certain extent of a register in a retail store, or may have a size larger than the certain extents.

Hereinafter, specific examples of the device configuration and the like will be described.

### First Example

FIG. 1 illustrates a first example of the electronic tag writing system 1. This example includes the writing device 60, the tag supply unit 20 that supplies the electronic tag 10 to the writing device 60, and the information acquisition unit 70, and writing information acquired by the information acquisition unit 70 is written to the electronic tag 10 supplied from the tag supply unit 20 by the writing device 60. Accordingly, in the system of this example, the electronic tag 10 to which information different in correspondence with each of the objects 50 is written can be automatically and sequentially manufactured.

In the first example, the information acquisition unit 70 may be any one described above, but the example illustrated in FIG. 1(a) includes the individual information sensor 71, and writing information including individual information 51 detected by the individual information sensor 71 is written to the electronic tag 10. On the other hand, the information acquisition unit 70 in an example illustrated in FIG. 1(b) is configured to read out writing information from the storage unit 80. An example illustrated in FIG. 1(c) has a configuration in which the information acquisition units 70 of both the examples are combined, the individual information 51 detected by the individual information sensor 71 and secondary information read out from the storage unit 80 on the basis of the individual information 51 are written to the electronic tag 10 as the writing information.

In the first example, the electronic tag 10 is externally applied to the objects 50. Accordingly, as in an application example to be described later, it is preferable to include a tag attachment unit that attaches the electronic tag 10 for which writing is completed by the writing device 60 to the objects 50, but a worker may manually attach the electronic tag 10 to the objects 50. Note that, the attachment stated here includes, particularly, putting in a package of the objects 50 in addition to fixing or connection to the objects 50.

For example, as in the examples illustrated in FIGS. 1(a) and 1(c), the system of the first example can be set as a stationary type one device E0 as a whole. In this case, writing to the electronic tag 10 can be automatically performed in correspondence with input to the device E0, or when acquiring the writing information by the information acquisition unit 70.

In addition, as in the example illustrated in FIG. 1(b), constituent elements other than the storage unit 80 can be set as a stationary type first device E1, the storage unit 80 can be set as a second device E2, and the information acquisition unit 70 of the first device E1 can be configured to perform reading-out from the storage unit 80 of the second device E2. In this case, the information acquisition unit 70 sequentially acquires the writing information in correspondence with processing initiation input for the second device E2, and writing to the electronic tag 10 can be performed.

In the examples, in a case where a worker manually performs attachment of the electronic tag 10 to the objects 50, a discharge part or a delivery part for the electronic tag 10 may be installed in a device including the writing device 60, and the worker can receive the electronic tag 10 and can attach the electronic tag 10 to the objects 50.

### Second Example

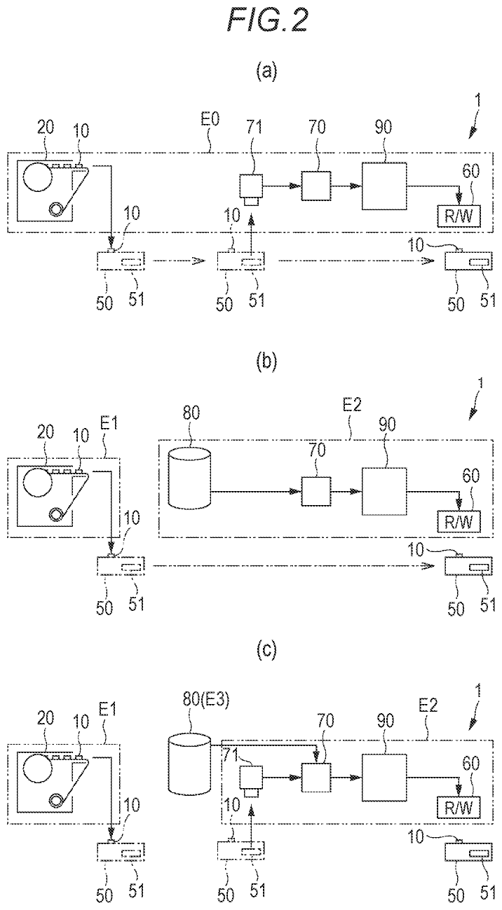

FIG. 2 illustrates a second example of the electronic tag writing system 1. This example includes a tag attachment unit that attaches the electronic tag 10 to the objects 50, and the tag supply unit 20 that supplies the electronic tag 10 to the tag attachment unit, and writing device 60 writes writing information acquired by the information acquisition unit 70 to the electronic tag 10 attached to the objects 50. In this electronic tag writing system 1, for example, in a retail store or the like, after attaching an unwritten electronic tag 10 to received products of which a type (a size, packaging, or the like), a quantity, and the like are different (small-quantity and many-kinds), writing information can be written to the electronic tag 10. In this case, in addition to performing attachment and writing of the electronic tag 10 for each of the objects 50, after attaching the electronic tag 10 to all of the objects 50 to be processed at a time, writing can also be sequentially performed to the electronic tag 10 that is attached to each of the objects 50.

In the second example, the information acquisition unit 70 may be any one described above. However, the example illustrated in FIG. 2(a) includes the individual information sensor 71, and writing information including the individual information 51 detected by the individual information sensor 71 is written to the electronic tag 10. On the other hand, the information acquisition unit 70 of an example illustrated in FIG. 2(b) is configured to read out the writing information from the storage unit 80. An example illustrated in FIG. 2(c) has a configuration in which the information acquisition units 70 of both the examples are combined, and the individual information 51 detected by the individual information sensor 71 and secondary information read out from the storage unit 80 on the basis of the individual information 51 are written to the electronic tag 10 as the writing information.

For example, as in the example illustrated in FIG. 2(a), the system of the second example can be set as the stationary type one device E0 as a whole. In this case, as in an application example to be described later, attachment of the electronic tag 10 to the objects 50, acquisition of the writing information by the individual information sensor 71 after (or before) the attachment, and writing by the writing device 60 can be automatically performed while conveying the objects 50 by a conveyor.

As in the example illustrated in FIG. 2(b), the tag attachment unit and the tag supply unit 20 can be set as the stationary type first device E1, and the information acquisition unit 70, the control unit 90, the writing unit, and the storage unit 80 can also be set as the stationary second device E2. In this case, after a worker performs attachment of the electronic tag 10 with respect to the object 50 by operating the first device E1, the worker can perform information acquisition and writing by operating the second device E2. This example has an advantage that the first device E1 and the second device E2 can be separately installed.

In addition, as illustrated in FIG. 2(c), the tag attachment unit and the tag supply unit 20 can be set as a handy type or stationary type first device E1, the information acquisition unit 70, the control unit 90, and the writing unit can be set as a handy type second device E2, and the storage unit 80 can be set as a stationary type third device E3. In this case, the worker performs attachment of the electronic tag 10 to the objects 50 by operating the first device E1. On the other hand, the worker detects the individual information 51 of the objects 50 by holding the individual information sensor 71 of the second device E2 over each of the objects 50, information acquisition from the storage unit 80 of the third device E3 is performed by the information acquisition unit 70 of the second device E2 on the basis of the individual information 51, writing information is created, and writing to the electronic tag 10 attached to the objects 50 can be performed by holding the writing device 60 of the second device E2 over each of the objects 50.

### Third Example

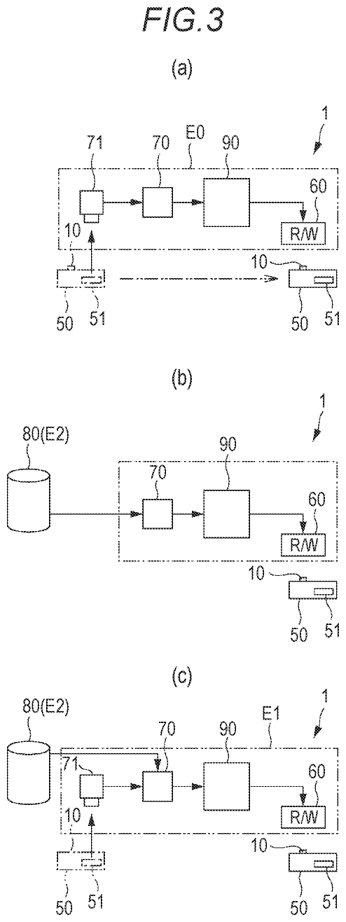

FIG. 3 illustrates a third example of the electronic tag writing system 1. This example is different from the second example in that the tag supply unit 20 and the tag attachment unit are not provided, and writing is performed with respect to the electronic tag 10 attached to the objects 50 in advance. For example, in a case where a producer ships products in a state where an unwritten electronic tag 10 is attached to a container or a package of the products, a retail store can perform writing to the electronic tag 10 attached to received products by using the system.

In the third example, the information acquisition unit 70 may be any one described above. However, an example illustrated in FIG. 3(a) includes the individual information sensor 71, and writing information including the individual information 51 detected by the individual information sensor 71 is written to the electronic tag 10. On the other hand, the information acquisition unit 70 in an example illustrated in FIG. 3(b) is configured to read out the writing information from the storage unit 80. An example illustrated in FIG. 3(c) has a configuration in which the information acquisition units 70 of both the examples are combined, and the individual information 51 detected by the individual information sensor 71 and secondary information read out from the storage unit 80 on the basis of the individual information 51 are written to the electronic tag 10 as the writing information.

Since the system of the third example is not provided with the tag attachment unit and the tag supply unit 20, the system is appropriate for a compact system. For example, as in the example illustrated in FIG. 3(a), the entirety can be set as a handy type one device E0. In this case, a worker holds the device E0 by a hand and holds the individual information sensor 71 of the device E0 over each of the objects 50 to detect the individual information 51 of the objects 50, the writing information including the individual information 51 is created, and writing is performed by holding the writing device 60 of the device E0 over the electronic tag 10 attached to the objects 50.

As in an example illustrated in FIG. 3(b), constituent elements other than the storage unit 80 can be set as a handy type first device E1, and the storage unit 80 can be set as the stationary type second device E2. In this case, a worker operates the first device E1 to perform information acquisition from the second device E2, the writing information is created, and writing can be performed by holding the writing device 60 of the first device E1 over the electronic tag 10 attached to the objects 50.

In addition, as in an example illustrated in FIG. 3(c), constituent elements other than the storage unit 80 can be set as the stationary type first device E1, and the storage unit 80 can be set as the stationary type second device E2. In this case, the worker holds each of the objects 50 by hands over the individual information sensor 71 of the first device E1 to detect the individual information 51 of the objects 50, information acquisition from the storage unit 80 of the second device E2 is performed by the information acquisition unit 70 of the first device E1 on the basis of the individual information 51, the writing information is created, and writing to the electronic tag 10 of the objects 50 can be performed by holding each of the objects 50 over the writing device 60 of the first device E1.

### Fourth Example

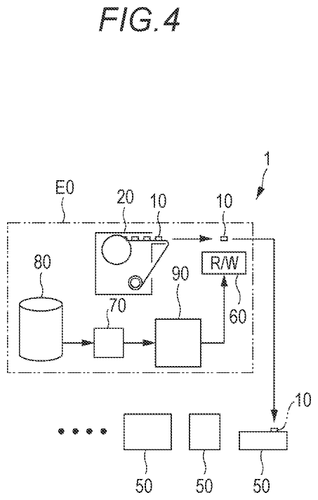

FIG. 4 illustrates a fourth example of the electronic tag writing system 1. This example is different from the first example in that the writing information and the processing order are stored in the storage unit 80 in association with each other, and the writing information associated with the processing order is written to the electronic tag 10 by the writing device 60 in accordance with the processing order acquired from the storage unit 80 by the information acquisition unit 70. In this example, since the writing information associated with the processing order is written to the electronic tag 10 in accordance with the processing order read out from the storage unit 80, in the case of attaching the electronic tag 10 with respect to a plurality of kinds of objects 50 to be processed (handled) in a determined order, information different in correspondence with each of the objects 50 can be automatically written.

In the fourth example, the electronic tag 10 is externally applied to the objects 50. Accordingly, as in an application example to be described later, it is preferable to include the tag attachment unit that attaches the electronic tag 10 for which writing is completed by the writing device 60 to the objects 50, but a worker may manually attach the electronic tag 10 to the objects 50. Note that, the attachment stated here includes, particularly, putting in a package of the objects 50 in addition to fixing or connection to the objects 50.

For example, as in the example illustrated in FIG. 4, the system of the fourth example may be set as the stationary type one device E0 as a whole. In this case, input of designating processing objects 50 (a range of processing targets) is performed to the device E0, the processing order and the writing information which are necessary are acquired by the information acquisition unit 70, and the writing information associated with the processing order can be written to the electronic tag 10 in accordance with the processing order.

### Fifth Example

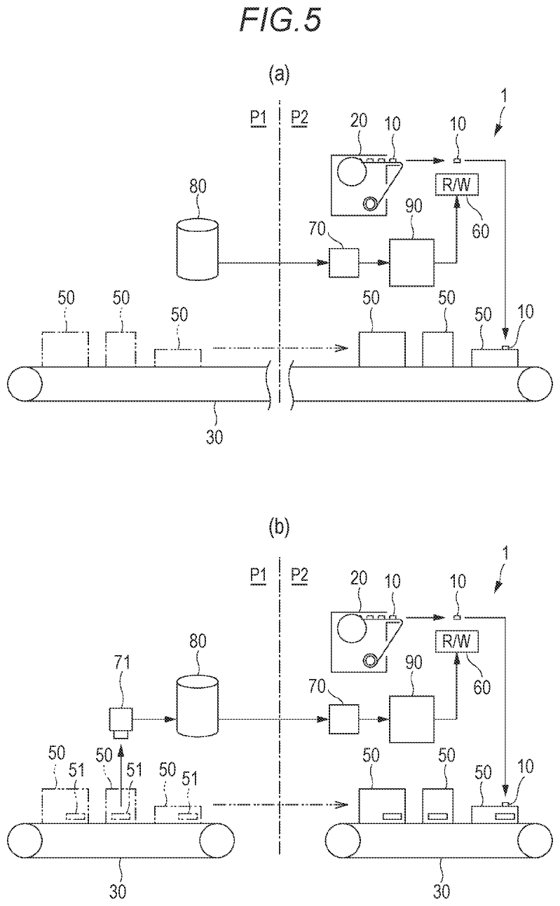

FIG. 5 illustrates a fifth example of the electronic tag writing system 1. This example is different from the fourth example in that in a first process in production and distribution of the objects 50, the processing order of the objects 50 in the process and the writing information of each of the objects 50 are acquired and are stored in the storage unit 80, and in a second process of processing the objects 50 in the processing order downstream of the first process, the writing information associated with the processing order is sequentially written to the electronic tag 10 by the writing device 60 in accordance with the processing order.

In this system, for example, writing to the electronic tag 10 is sequentially performed in accordance with the processing order in a first process P1 of processing (handling) the objects 50 in a constant order as in a transfer process or an inspection process of the objects 50 in production facility of the objects 50, and a transportation process in distribution of the objects 50, and the like, and a second process P2 of processing the objects 50 in the processing order after storing the processing order and the writing information of the objects 50 in the storage unit 80 in advance. Accordingly, since the electronic tag 10 after writing is sequentially attached to the objects 50, the electronic tag 10 to which information different in correspondence with each of the objects 50 is written can be automatically attached to the objects 50.

In the case of storing the writing information of the processing order of the objects 50 and the writing information of each of the objects 50 in the storage unit 80 in the first process P1, and in a case where the storage unit 80 is a storage unit 80 of an existing system (a production management system, a distribution system, or the like) as illustrated in FIG. 5(a), or in a case where the storage unit 80 is a storage unit 80 that stores information copied from the information of the storage unit 80 of the existing system, or information obtained by performing change or addition to the information, as a result of operation of the existing system, the processing order of the objects 50 in the first process P1 and the writing information of each of the objects 50 are stored in the storage unit 80. In addition, as illustrated in FIG. 5(b), the individual information sensor 71 may be installed in facility for the first process P1, the processing order of the objects 50 and the writing information of each of the objects 50 can also be acquired on the basis of at least one of a part or the entirety of primary information such as the individual information 51 detected by the individual information sensor 71, and secondary information acquired on the basis of the acquired primary information, and the processing order and the writing information can also be stored in the storage unit 80.

For example, the system of the fifth example can also be constructed in a single conveyance line P0 of production facility or distribution facility as illustrated in FIG. 5(a). In addition, as illustrated in FIG. 5(b), the first process P1 may be set as a shipping process of the production facility or the like, the individual information sensor 71 and the storage unit 80 may be installed in the facility, the second process P2 of processing the objects 50 in the same processing order as in the first process P1 downstream of the first process P1 may be set as a carrying-in process of the distribution facility or the like, and the information acquisition unit 70, the control unit 90, and the writing device 60 may also be installed in the facility. In the example illustrated in FIG. 5, the processing order of the objects 50 is set not to vary so as to perform processing while conveying the objects 50 by the conveyor 30 in any example, but continuous conveyance is not necessary in the first process P1 and a process of performing writing to the electronic tag 10 downstream of the first process P1.

In the fifth example, in a case where a worker manually performs attachment of the electronic tag 10 to the objects 50, a discharge part or a delivery part for the electronic tag 10 may be installed in a device including the writing device 60, and the worker can receive the electronic tag 10 and can attach the electronic tag 10 to the objects 50.

### Sixth Example

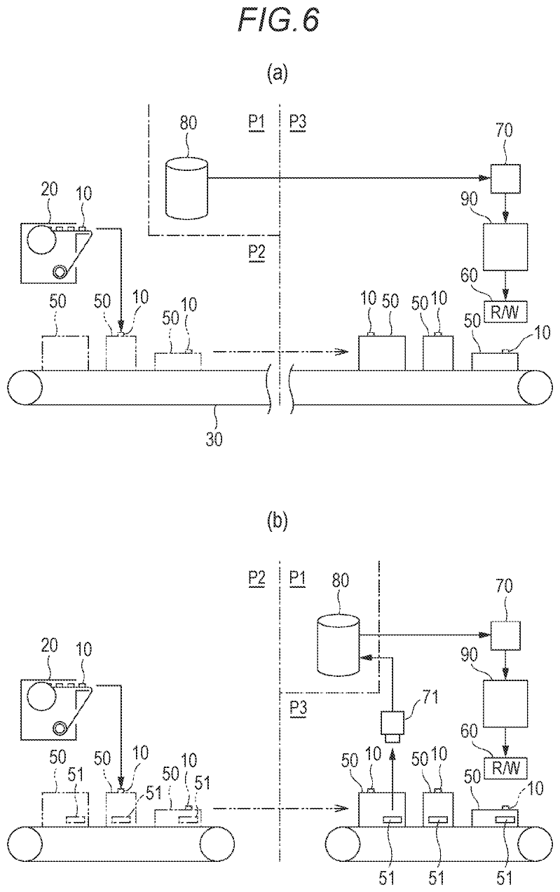

FIG. 6 illustrates a sixth example of the electronic tag writing system 1. This example includes a tag attachment unit that attaches the electronic tag 10 to the objects 50, and the tag supply unit 20 that supplies tags to the tag attachment unit. In the first process P1 in the production and distribution of the objects 50, the processing order of the objects 50 in the process, and the writing information of each of the objects 50 are acquired and are stored in the storage unit 80, in the second process P2 in the production and distribution of the objects 50, the electronic tag 10 is attached to the objects 50 by the tag attachment unit, and in a third process P3 of processing the objects 50 in the same processing order downstream of the first process P1 and the second process P2, the writing information associated with the processing order is sequentially written to the electronic tag 10 attached to the objects 50 by the writing device 60 in accordance with the processing order.

In this system, for example, in the first process P1 of processing (handling) the objects 50 in a constant order as in a transfer process or an inspection process of the objects 50 in production facility of the objects 50, a transportation process in distribution of the objects 50, and the like, the processing order and the writing information of the objects 50 are stored in the storage unit 80 in advance. In addition, in the second process P2 that is performed simultaneously with or before or after the first process P1, the electronic tag 10 is attached to the objects 50. Then, in a third process P3 of processing the objects 50 in the processing order, writing to the electronic tag 10 attached to the objects 50 is sequentially performed in accordance with the processing order. Accordingly, the electronic tag 10 to which information different in correspondence with each of the objects 50 is written can be automatically attached to the objects 50.

More specifically, when transporting products of which a type (a size, packaging, or the like), a quantity, and the like are different (small-quantity and many-kinds) from a distribution center to a product delivery destination such as a retail store, it is possible to realize an aspect in which storage of the processing order and the writing information with respect to the storage unit 80 and attachment of the electronic tag 10 are performed at the distribution center (the first process and the second process), and writing to the electronic tag 10 is performed in the product delivery destination (the third process). Note that, in the tag attachment unit, in addition to attachment of the electronic tag 10 and writing to the electronic tag 10 for each of the objects 50, after attaching the electronic tag 10 to all of the objects 50 which are processed at a time, writing to the electronic tag 10 attached to each of the objects 50 can also be sequentially performed.

A method of storing the processing order of the object 50 and the writing information of each of the objects 50 in the storage unit 80 in the first process P1 in the sixth example is similar as in the fifth example.

For example, the system of the sixth example can also be constructed in a single conveyance line of production facility or distribution facility as illustrated in FIG. 6(a). In addition, as illustrated in FIG. 6(b), the first process P1 may be set as a shipping process of the production facility or the like, the tag attachment unit, the tag supply unit 20, the individual information sensor 71, and the storage unit 80 may be installed in the facility, a process of processing the objects 50 in the same processing order as in the first process P1 downstream of the first process P1 may be set as a carrying-in process of the distribution facility or the like, and the information acquisition unit 70, the control unit 90, and the writing device 60 may also be installed in the facility. In the example illustrated in FIG. 6, the processing order of the objects 50 is set not to vary so as to perform processing while conveying the object 50 by a conveyor in any example, but continuous conveyance is not necessary in the first process P1 and a process of performing writing to the electronic tag 10 downstream of the first process P1.

### Seventh Example

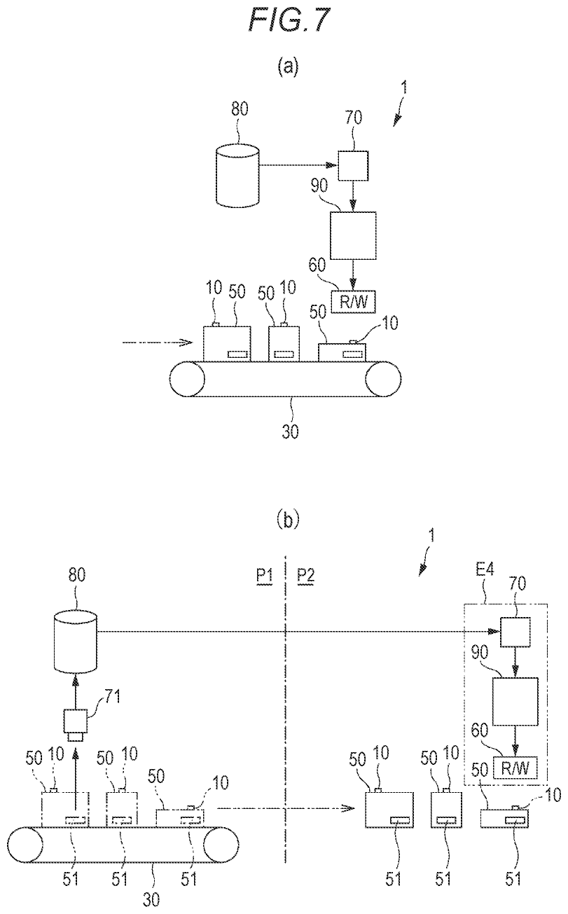

FIG. 7 illustrates a seventh example of the electronic tag writing system 1. This example is different from the sixth example in that the tag supply unit 20 and the tag attachment unit are not provided, and writing is performed to the electronic tag 10 attached to the objects 50. That is, the electronic tag writing system 1 is a system that does not perform supply of the electronic tag 10 and attachment to the objects 50. In a process of processing the objects 50 in the processing order in production and distribution, the electronic tag writing system 1 writes the writing information associated with the processing order to the electronic tag 10 attached to the objects 50 by the writing device 60 in accordance with the processing order acquired by the information acquisition unit 70. More specifically, when transporting products of which a type (a size, packaging, or the like), a quantity, and the like are different (small-quantity and many-kinds) from a producer to a retail store or the like, the producer ships a product in a state in which an unwritten electronic tag 10 is attached to the product, or a container or a package of the product, and at a retail store or a distribution center of the product, information different in correspondence with each of objects 50 can be automatically written in a process of handling the product in a determined order.

A method of storing the processing order of the objects 50 and the writing information of each of the objects 50 in the storage unit 80 in the seventh example may be similar as in the fifth example, and in addition to this, the processing order and the writing information may also be stored in the storage unit 80 on the basis of information acquired in a process other than the production and distribution process of the objects 50.

For example, the system of the seventh example can also be constructed in a single conveyance line of production facility or distribution facility as illustrated in FIG. 7(a). In addition, as illustrated in FIG. 7(b), the individual information sensor 71 and the storage unit 80 may be provided in facility for a carrying-out process (first process P1) in the distribution facility, and a handy type device E4 including the information acquisition unit 70, the control unit 90, and the writing device 60 may also be provided in facility for a carrying-in process (second process) in a retail store in which the objects 50 are treated as in the same processing order as in the first process P1 downstream the first process P1. In this case, a worker can perform writing to the electronic tag 10 attached to the object 50 by holding the writing device 60 of the handy type device E4 over the electronic tag 10. In the example illustrated in FIG. 7(a), the processing order of the objects 50 is set not to vary so as to perform processing while conveying the objects 50 by a conveyor, but continuous conveyance is not necessary in the first process P1 and in the second process P2 of performing writing to the electronic tag 10 downstream of the first process P1. Accordingly, the system configuration as in FIG. 7(b) is also possible.

### Other Examples

A partial configuration of each example from the first example to the seventh example is applicable to other examples within a range not deteriorating a basic configuration of the other examples. In addition, a partial configuration of an application example to be described later is also applicable from the second example to the seventh example within a range not deteriorating the basic configuration of the examples.

### Application Example

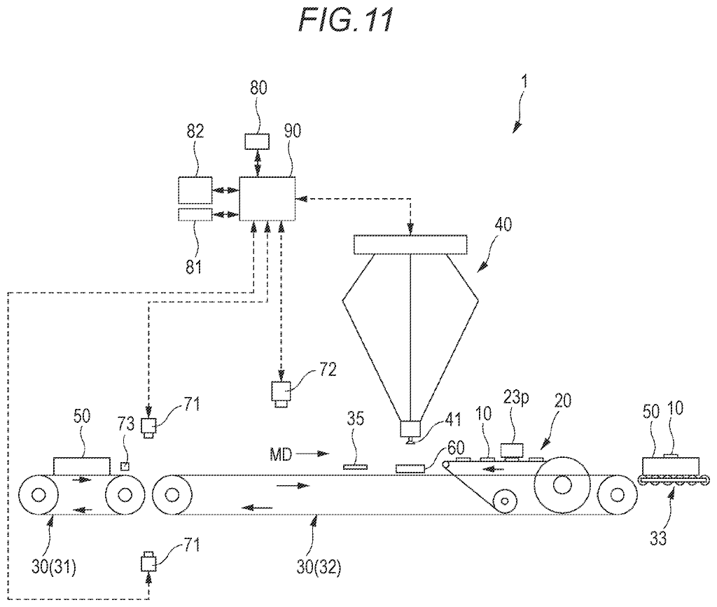

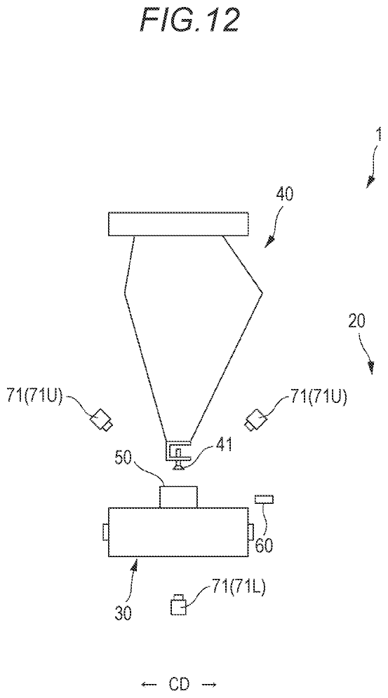

FIG. 11 and FIG. 12 illustrate the electronic tag writing system 1 to which the first example is applied. The electronic tag writing system 1 includes the tag supply unit 20 that sequentially supplies the electronic tag 10 having an adhesive surface 11, and sticking units 30 and 40 which stick the electronic tag 10 supplied from the tag supply unit 20 to the objects 50 such as a sticking target product. In addition, the electronic tag writing system 1 includes the writing device 60 that writes the writing information relating to the objects 50 to the electronic tag 10 in a process of being stuck to the objects 50, the individual information sensor 71 that detects individual information of the objects 50, and the control unit 90 that writes writing information including at least one of a part or the entirety of the individual information detected by the individual information sensor 71, and association information associated with the detected individual information to the electronic tag 10 to be stuck to the objects 50, for which detection of the individual information has been performed, by the writing device 60.

Accordingly, in the electronic tag writing system 1, within the device, the individual information of the objects 50 is detected, and the writing information based on the detection result is written to the electronic tag 10 to be stuck to the objects 50 for which detection of the individual information has been performed. Accordingly, even in the case of sticking the electronic tag 10 to a plurality of kinds of objects 50 in a random order, the electronic tag 10 to which appropriate information is automatically written can be stuck. For example, in the case of sticking the electronic tag 10 at a retail store, a worker can stick the electronic tag 10 to which appropriate information is sequentially and automatically written to received products of which a type (a size, packaging, or the like), a quantity, and the like are different (small-quantity and many-kinds) without being conscious of the kind of the objects 50. Hereinafter, respective parts will be sequentially described.

(Sticking Unit)

The sticking unit 30 or 40 may have a configuration capable of being operated by a worker like a handy type labeler as long as the electronic tag 10 supplied from the supply unit of the electronic tag 10 can be stuck to the objects 50 as a sticking target. In this case, it is preferable that the individual information sensor 71 or the writing device 60 is built in, but at least one side of the supply unit of the electronic tag 10 and the sticking unit, and the individual information sensor 71 and the writing device 60 may also be set as a separate body. The sticking unit 30 or 40 in the illustrated example is configured to include the conveyor 30 that conveys the objects 50 as a sticking target of the electronic tag 10, and the robot 40 that receives the electronic tag 10 supplied from the tag supply unit 20 and sticks the electronic tag 10 to the objects 50 conveyed on the conveyor 30. In this manner, in the case of sticking the electronic tag 10 to the objects 50 in conveyance by the robot 40 while conveying the objects 50 by the conveyor 30, a number of objects 50 can be automatically and continuously processed.

(Conveyor)

As the conveyor 30, known all conveyors can be used as long as a moving body can be moved in a conveyance direction by a drive force of a driving source, and the objects 50 on the moving body can be conveyed, and for example, a belt conveyor, a plate conveyor, or the like in which an upper surface is a loading surface can be appropriately used. It is preferable that the conveyor 30 has the loading surface having a width wider than a width of the objects 50, for example, in order for a worker to load the objects 50 of many kinds different in a size without being conscious of a position or a direction of the objects 50. Of course, the conveyor 30 may have a configuration in which the kind and the loading position (including the direction) of the objects 50 are constant. In addition, the objects 50 can also be mechanically loaded on the conveyor 30.

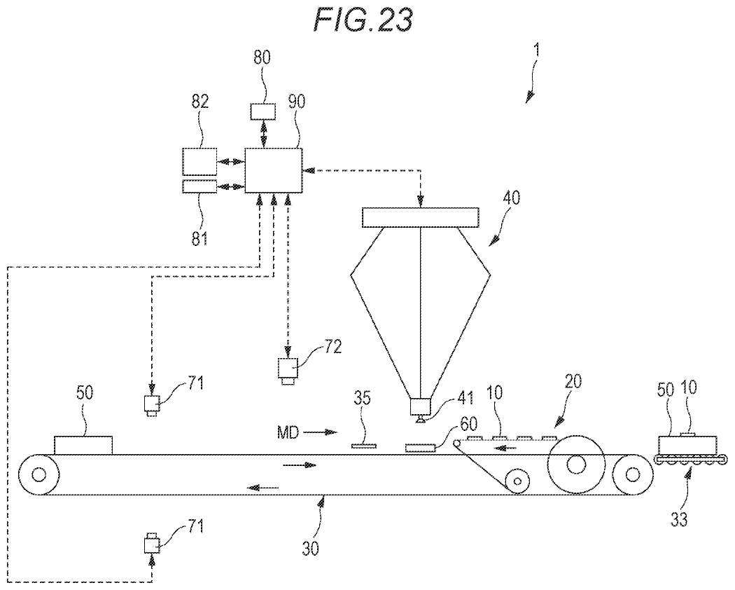

As in the example illustrated in FIG. 11 and the like, the conveyor 30 can also be configured by connecting a plurality of the conveyors 31 or 32, and only one conveyor can also be provided as illustrated in FIG. 23. In addition, when a free roller conveyor 33 is installed on the most downstream side of the conveyor 30, the objects 50 are pushed out onto the free roller conveyor 33 and are stopped, and thus the subsequent work becomes easy.

It is preferable that the conveyor 30 continuously performs conveyance at a constant speed, but can also be intermittently driven with a standby time at an appropriate position to match various kinds of timing such as sticking timing of the electronic tag 10.

(Individual Information Sensor)

It is preferable that the individual information sensor 71 can perform detection with respect to all surfaces of the objects 50. According to this, in the case of performing detection by the individual information sensor 71 while conveying the objects 50 by the conveyor 30, a device configuration illustrated in FIG. 11 or the like is preferable. That is, the electronic tag writing system 1 includes a first conveyor 31 that conveys the objects 50, and a second conveyor 32 that is continuous to a downstream side of the first conveyor 31 with a gap and receives and conveys the objects 50 conveyed from the first conveyor 31. The individual information sensor includes a lower sensor 71L that detects individual information of the objects 50 from a downward side of the objects 50 through the gap between the first conveyor 31 and the second conveyor 32, and an upper sensor 71U that detects the individual information of the objects 50 from an upper side of the objects 50 on an upstream side of a sticking possible range of the robot 40.

In this manner, when the conveyor 30 is divided into the first conveyor 31 and the second conveyor 32, and the gap in a delivery portion is used, the individual information of the objects 50 can be detected from both the upper side and the lower side, and thus it is possible to continuously process a plurality of kinds of sticking objects 50 in which positions of the individual information in the objects 50 are vertically different without being conscious of the vertical direction.

Particularly, in a case where detection in a wide range is possible by using an imaging sensor as the individual information sensor 71, as illustrated in FIG. 12, it is preferable to install an upper sensor 71U that performs detection from a diagonally upper side on one side of a CD direction, an upper sensor 71U that performs detection from a diagonally upper side on the other side of the CD direction, and a lower sensor 71L that performs detection from an immediately below side of the conveyor 30 with the conveyor 30 interposed therebetween because four surfaces of the objects can be detected by the three sensors. That is, as illustrated in FIGS. 10(a), 10(b), and 10(c), individual information of an upper surface, side surfaces, and a lower surface of the objects 50 can be detected. Note that, an MD direction represents a mechanical direction (conveyance direction), and the CD direction represents a lateral direction orthogonal to the MD direction.

(Tag Supply Unit)

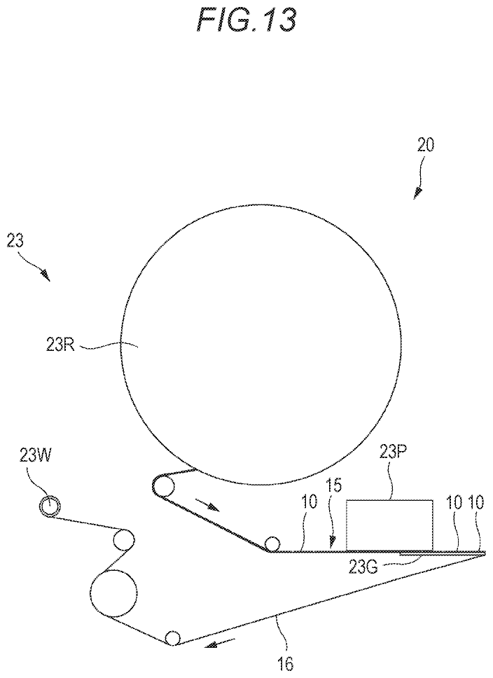

The tag supply unit 20 is not particularly limited, and all known supply mechanisms (for example, mechanisms described in Patent Document 1 to Patent Document 5, and the like) as long as the electronic tag 10 can be supplied to the sticking unit 30 and 40. FIG. 13 illustrates an example of the tag supply unit 20 that is used in a state of being equipped with an electronic tag roll 23R. A continuous strip-shaped electronic tag sheet 15 is wound around the electronic tag roll 23R in a roll shape, and the electronic tag sheet 15 includes the electronic tag 10 that is repetitively stuck in a continuous direction of a continuous strip-shaped release sheet 16 with predetermined intervals. The electronic tag roll 23R is rotatably supported to a rotating shaft (not illustrated).

In addition, the tag supply unit 20 assumes a case where the electronic tag is stuck to the objects 50 by the robot 40 to be described later, and includes a delivery part that conveys the electronic tag sheet 15 in a continuous direction thereof, sequentially peels off the electronic tag 10 from a downstream side of the conveyance direction, and conveys the electronic tag 10 to the robot 40, and a winding shaft 23W that winds the continuous strip-shaped release sheet 16 after peeling off the electronic tag 10. The delivery part includes a folding-back guide 23G (may be a rotating shaft or non-rotating shaft in addition to a plate shape in the illustrated example) that guides the release sheet 16 to be folded back to a side opposite a side where the electronic tag 10 is provided, and peeling-off of the electronic tag sheet 15 is performed through folding-back of the release sheet 16. The winding shaft 23W is rotationally driven by a stepping motor (not illustrated), and is set to perform winding so that the subsequent electronic tag 10 is moved to a leading position at appropriate control timing whenever the leading electronic tag 10 is peeled off (that is, sheet by sheet).

After being wound off from the electronic tag roll 23R, the electronic tag sheet 15 is folded back at an acute angle by the folding-back guide 23G. At the time of the folding-back, the electronic tag sheet 15 can be conveyed to the robot 40 directly or indirectly through a belt conveyor or the like so that the electronic tag 10 having rigidity is naturally peeled off from the release sheet 16. The release sheet 16 that remains after the electronic tag 10 is peeled off is wound around the winding shaft 23W.

The tag supply unit 20 can be provided with a printer 23P that prints predetermined additional information such as a logo of a retail store, description relating to the electronic tag 10, and a two-dimensional barcode for guiding to a WEB site associated with this on a surface (non-adhesive surface 11) of the electronic tag 10 on the electronic tag sheet 15. According to this, the additional information can be sequentially printed on the electronic tag 10 that is used.

(Conveyance of Electronic Tag to Robot)

In the case of sticking an electronic tag to the objects 50 by the robot 40, the robot 40 is not particularly limited as long as the robot 40 receives the electronic tag 10 supplied from the tag supply unit 20 and sticks the electronic tag 10 to the objects 50 conveyed on the conveyor 30. However, as in an illustrated example, it is preferable that a suction unit 41 configured to hold an object trough air suction is provided as an end effector, the electronic tag 10 stuck onto a first belt 21B of a first belt conveyor 21 is suctioned by the suction unit 41, and the electronic tag 10 is peeled off from the belt due to movement of the suction unit 41 and is stuck to the objects 50. The suction unit 41 in the illustrated example is a tubular body in which a rubber cup is formed at a tip end portion, but known structures and materials can be employed without limitation thereto.

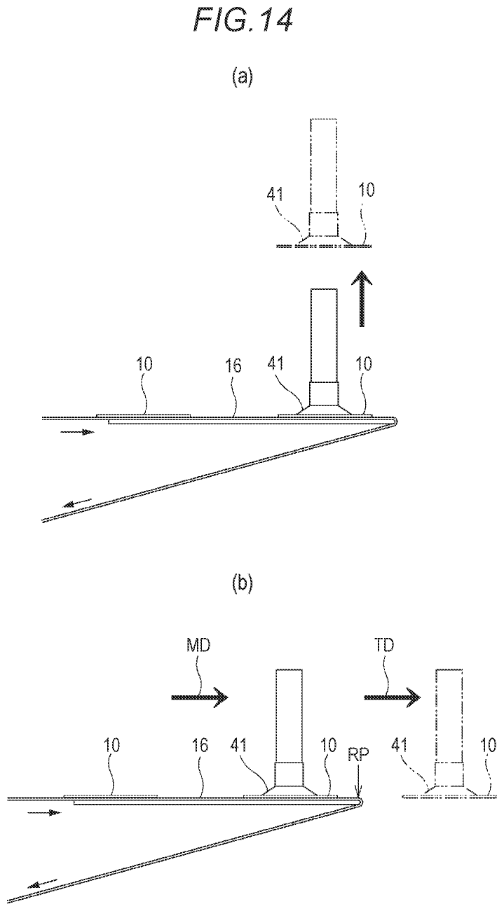

Conveyance of the electronic tag 10 to the robot 40 provided with the suction unit 41 can also be performed by peeling off the electronic tag 10 from the belt by ascending the suction unit 41 in a state where the suction unit 41 of the robot 40 suctions the surface of the electronic tag 10 stuck onto the release sheet 16 as illustrated in FIG. 14(a) (for example, refer to Patent Document 5). However, in the case of peeling off the electronic tag 10 stuck onto the release sheet 16 through ascending movement of the suction unit 41, there is a concern that conveyance may not be reliable.

Here, as illustrated in FIG. 14(b), there is suggested a delivery mechanism in which after the suction unit 41 suctions the electronic tag 10 on the release sheet 16 on a forward side in comparison to a folding-back initiation position RP of the release sheet 16 in the transfer part through driving control of the robot 40, the suction unit 41 is moved in a state of suctioning the electronic tag 10 in combination with the release sheet 16 up to the folding-back initiation position RP, and is moved at the same speed as in the release sheet 16 in a tangential direction TD of a movement direction MD of the release sheet 16 in a state of suctioning the electronic tag 10 after the folding-back initiation position RP to convey the electronic tag 10 peeled off from the release sheet 16 due to folding-back of the release sheet 16 to the suction unit 41. In this case, the electronic tag 10 can be peeled off from the release sheet 16 in a state of being held to the suction unit 41 mainly by using a feeling force acting on the electronic tag 10 due to folding-back of the release sheet 16 while hardly using a force due to detachment of the suction unit 41 from the release sheet 16. Accordingly, in a very simple mechanism, reliable conveyance of the electronic tag 10 is possible with less absorption force.

In a state where the suction unit 41 suctions the electronic tag 10, since the suction unit 41, the electronic tag 10, and the release sheet 16 are integrated, the suction unit 41 can also be moved by using a movement force of the release sheet 16 only through supporting to be free in a movement direction of the release sheet 16 without driving the suction unit 41 by a driving source. However, in order to realize a more reliable operation, it is preferable that the suction unit 41 is moved by driving of the robot 40 in combination with the release sheet 16 up to the folding-back initiation position RP while suctioning the electronic tag 10, and is moved in the tangential direction TD of the movement direction MD of the release sheet 16 while suctioning the electronic tag 10 after the folding-back initiation position RP.

It is preferable that the release sheet 16 and the electronic tag 10 stuck to the release sheet 16 are stationary when the suction unit 41 suctions the electronic tag 10, but the suction unit 41 may suction the electronic tag 10 that moves in combination with the release sheet 16 without stopping the first belt 21B.

In this delivery mechanism, the support device may not be the robot 40 and may be a movable unit that moves at a constant cycle as long as the suction unit 41 is movably supported. In addition, the suction unit 41 of this delivery mechanism can also stick the electronic tag 10 to a conveyance device such as another conveyor, a temporary sticking stage, or another suction part without sticking the electronic tag 10 to final sticking objects 50 such as a product.

(Writing Device)

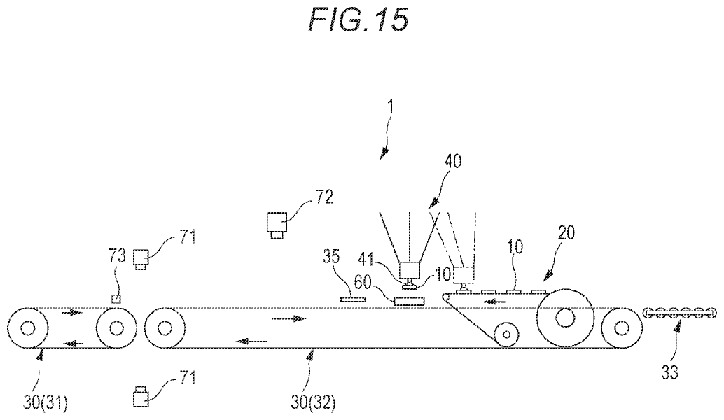

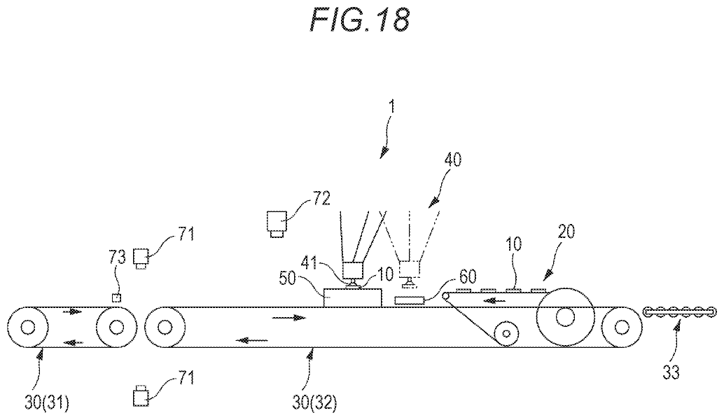

An installation position of the writing device 60 is not particularly limited as long as writing to the electronic tag 10 in a process until being struck to the objects 50 can be performed. For example, as illustrated in FIG. 11 and FIG. 12, the writing device 60 that writes the writing information relating to the objects 50 to the electronic tag 10 can be provided between the tag supply unit 20 and the conveyor 30 (a side of the conveyor 30 in the illustrated example). As illustrated in FIG. 15, the robot 40 can receive the electronic tag 10 supplied form the tag supply unit 20, can move the electronic tag 10 to a position where writing by the writing device 60 is possible and hold the electronic tag 10 for a constant time, and the writing device 60 can write the information relating to the objects 50 to the electronic tag 10 for the time. Then, as illustrated in FIG. 18, the robot 40 can move the electronic tag 10 from the writing device 60 to the objects 50 to stick the electronic tag 10 to the objects 50.

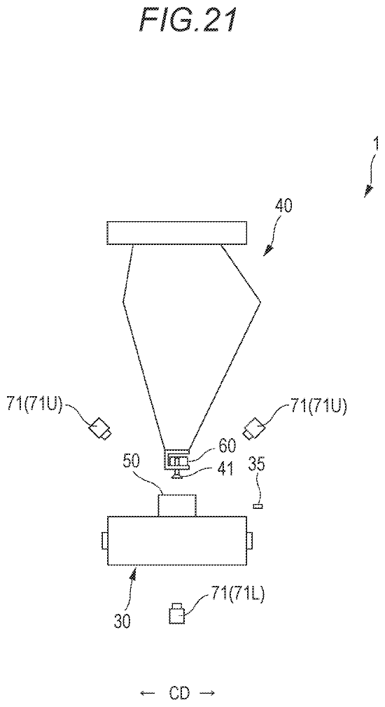

In addition, as illustrated in FIG. 21, the writing device 60 can be integrated with the suction unit 41, and writing can also be performed to the electronic tag 10 suctioned to the suction unit 41. In this case, information can be written to the electronic tag 10 at an appropriate stage in which the electronic tag 10 is stuck to the objects 50 after being suctioned to the suction unit 41 (may be a state where the suction unit 41 is stopped in addition to a state where the suction unit 41 is moving).

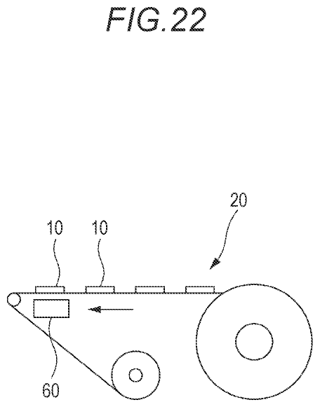

In addition, as illustrated in FIG. 22, the writing device 60 can be installed in a conveyance route of the electronic tag 10 within the tag supply unit 20, and information can also be written to the electronic tag 10 before being conveyed to the robot 40. In the example illustrated in FIG. 22, the writing device 60 is installed on a downward side of the electronic tag 10 to be subsequently transmitted in the tag supply unit 20, but appropriate change such as installation on a lateral side can be made.

(Robot)

In the case of performing sticking the electronic tag 10 by the robot 40, it is preferable that an appropriate sticking position different in correspondence with the kind of the objects 50 is designated, and the electronic tag 10 is stuck to the designated position. According to this, for example, the electronic tag 10 can be stuck to a position that is less likely to have an influence on products or a position that is less likely to deteriorate communication quality in correspondence with the objects 50. In addition, even in a case where a worker irregularly puts the objects 50 on the conveyor 30 without being conscious of a position (including a direction) of the objects 50 on the conveyor 30, the electronic tag 10 can be stuck to a designated sticking position of the objects 50. As illustrated in FIGS. 10(a) and 10(b), when the sticking position of the electronic tag 10 is set to the same surface as a detection surface of the individual information 51 and a position not overlapping the individual information 51, since the individual information 51 is not hidden by the electronic tag 10 after sticking the electronic tag 10, comparison and confirmation between the storage content of the electronic tag 10 and the individual information 51 of the objects 50 becomes easy. However, as illustrated in FIG. 10(c), the sticking position can also be set to a surface different from the detection surface of the individual information 51, or a position (not illustrated) overlapping a part or the entirety of the individual information 51.

Specifically, in the conveyor 30, an imaging device 72 that images the objects 50 conveyed on the conveyor 30 is installed upstream of the sticking possible range of the robot 40, and the individual information sensor 71 is installed upstream of the imaging device 72. In addition, the storage unit 80 that stores image information of the objects 50 and the designated sticking position in the objects 50 in association with each other is installed. Then, the control unit 90 compares, through image recognition, imaging information obtained by the imaging device 72 and image information of the objects 50 which is stored in the storage unit 80. When recognizing the objects 50 on the conveyor 30, the control unit 90 reads out the designated sticking position associated with the recognized objects 50 from the storage unit 80, detects a position of the objects 50 put on the conveyor 30, and causes the robot 40 to stick the electronic tag 10 to the designated sticking position in the objects 50 conveyed on the conveyor 30 on the basis of the designated sticking position and the position of the objects 50. Here, in the position information of the objects 50 put on the conveyor 30, position coordinates in the MD direction can be calculated on the basis of imaging timing by the imaging device 72 and a conveyance speed of the conveyor 30, position coordinates in a direction orthogonal to the MD direction and the direction can be obtained through image recognition from the imaging information obtained by the imaging device 72. In addition, the conveyance speed of the conveyor 30 can be detected, for example, by attaching a rotary encoder (not illustrated) to a driving system (for example, a belt) of the conveyor 30. Accordingly, the control unit 90 can cause the robot 40 to stick the electronic tag 10 to the designated sticking position in the objects 50 at timing for which the objects 50 are within the sticking possible range by the robot 40 on the basis of the position information.

### Operation Flow of Application Example

The electronic tag writing system 1 basically includes a step of putting the objects 50 on a supply position of the conveyor 30 by a worker, a step of detecting the individual information of the objects 50 conveyed by the conveyor 30 by the individual information sensor 71, a step of detecting the position information of the objects 50 conveyed by the conveyor 30, a step of writing writing information including at least one of a part or the entirety of the individual information detected by the individual information sensor 71 and association information acquired on the basis of the detected individual information to the electronic tag 10, and a step of sticking the electronic tag 10 to which the information is written to the objects 50 conveyed by the conveyor 30. As long as the steps can be executed, detailed control such as operation timing of each part can be appropriately performed.

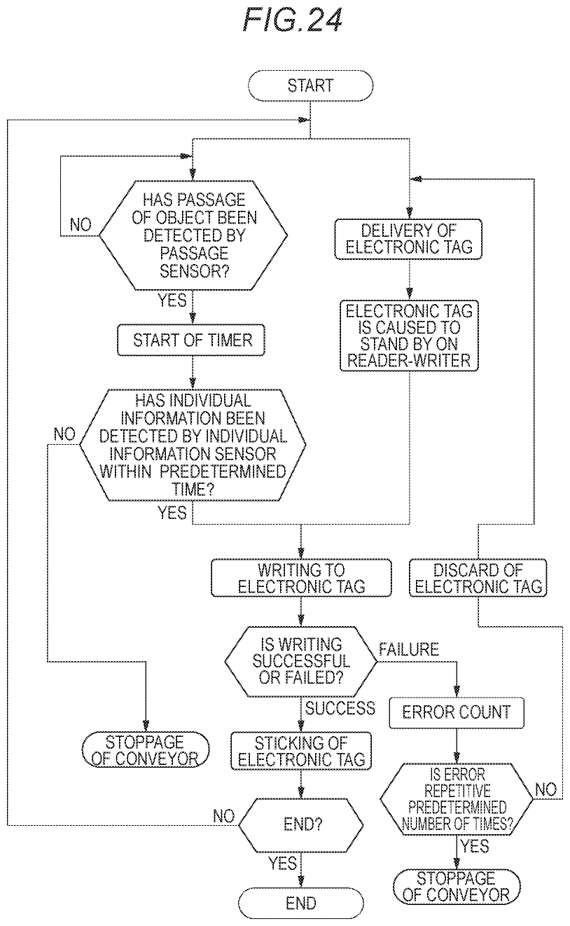

FIG. 24 is an example of an operation flow. When initiating an operation of the electronic tag writing system 1, the conveyor 30 is driven by the control unit 90, and detection and imaging by the individual information sensor 71 and the imaging device 72 are initiated. In addition, as illustrated in FIG. 15, the robot 40 receives the electronic tag 10 from the tag supply unit 20, moves the electronic tag 10 to a position where writing by the writing device 60 is possible, and stands by. In this manner, when the electronic tag 10 is caused to stand by at the position where writing by the writing device 60 is possible, time from detection of the individual information to writing to the electronic tag 10 can be shortened. According to this, sticking efficiency can be improved as a whole, a conveyance distance from the individual information sensor 71 to the sticking position can be shortened, and a reduction in size of the device can be realized. Instead of the configuration, in writing to the electronic tag 10 to be described later, from reception of the electronic tag 10 to the writing can be performed at a time.

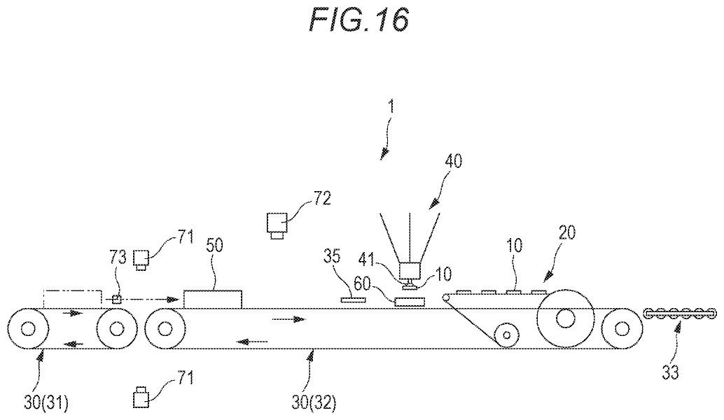

Next, a worker puts the objects 50 at a supply position (upstream of the individual information sensor 71) on the conveyor 30, and the objects 50 are conveyed. According to this, as illustrated in FIG. 16, first, the objects 50 passes through a detection position by the individual information sensor 71, and individual information of the objects 50 is detected at that time. Here, as in the illustrated example, a passage sensor 73 that detects passage of the objects 50 is installed in front of the individual information sensor 71, and in a case where the individual information is not detected by the individual information sensor 71 until passage of predetermined time (for example, several seconds) after detecting passage of the objects 50 by the passage sensor 73, the control unit 90 determines as individual information detection error and can stop at least the conveyor 30. In this case, of course, the entirety of the system 1 may be temporarily stopped. For example, when a position of target individual information (one-dimensional code or the like) in the objects 50 exists on a surface that cannot be detected by the individual information sensor 71, the above-described situation occurs. In this case, after taking out the objects 50, when a process starts from device starting again, the operation can be restarted without wasting the electronic tag 10. Note that, when the individual information detection error occurs, only the conveyor 30 is continuously driven for time capable of discharging the objects 50, and then it may automatically return to a normal operation. When the individual information detection error occurs, writing to the electronic tag 10 becomes difficult. As the passage sensor 73, it is possible to use a known passage sensor 73 such as a photosensor in which a light-emitting element and a light-receiving element are disposed to face each other with a passage position of the objects 50 on the conveyor 30 interposed therebetween, and shielding of light from the light-emitting element due to passage of the objects 50 is detected by a variation of an output of the light-receiving element.

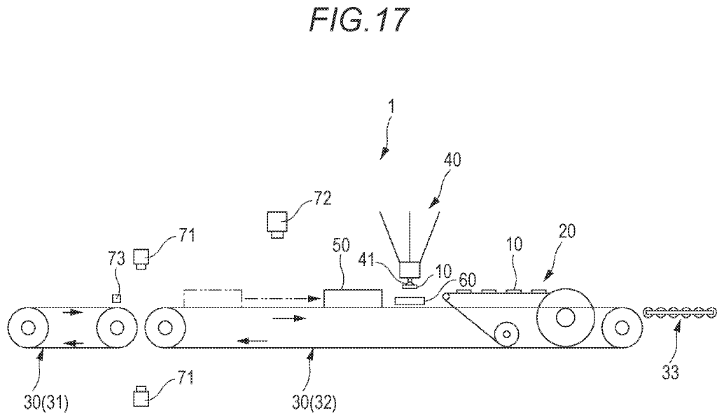

In a case where the individual information of the objects 50 is detected, the control unit 90 acquires or creates writing information including at least one of a part or the entirety of the individual information detected by the individual information sensor 71 and association information acquired on the basis of the detected individual information, and causes the writing device 60 to write the writing information to the electronic tag 10 to be stuck to the objects 50 for which detection of the individual information is performed. On the other hand, as illustrated in FIG. 17, the objects 50 are advanced to a destination on the conveyor 30 and are imaged by the imaging device 72, and an imaging result by the imaging device 72 is continuously input to the control unit 90. The control unit 90 compares the imaging information obtained by the imaging device 72 through image recognition and the image information of the objects 50 which is stored in the storage unit 80 with each other, and when recognizing the objects 50 on the conveyor 30, the control unit 90 reads out a designated sticking position associated with the recognized objects 50 from the storage unit 80, and detects a position of the objects 50 put on the conveyor 30. In addition, as illustrated in FIG. 18, the control unit 90 causes the robot 40 to stick the electronic tag 10 to the designated sticking position in the objects 50 at timing for which the objects 50 are within the sticking possible range by the robot 40 on the basis of the designated sticking position and the position of the objects 50. As illustrated in FIG. 11, the objects 50 to which the electronic tag 10 is stuck advance by the conveyor 30 and are taken out by a worker. As illustrated in FIG. 11, when a free roller conveyor 33 is installed on the most downstream side of the conveyor 30, the objects 50 are pushed out onto the free roller conveyor 33 and are stopped, and thus the subsequent work becomes easy. After the robot 40 sticks the electronic tag 10, the process returns to the initiation time, the robot 40 receives the electronic tag 10 from the tag supply unit 20 regardless of whether or not the objects 50 exist on the conveyor 30, the electronic tag 10 is moved to a position where writing by the writing device 60 is possible, and the electronic tag 10 stands by.

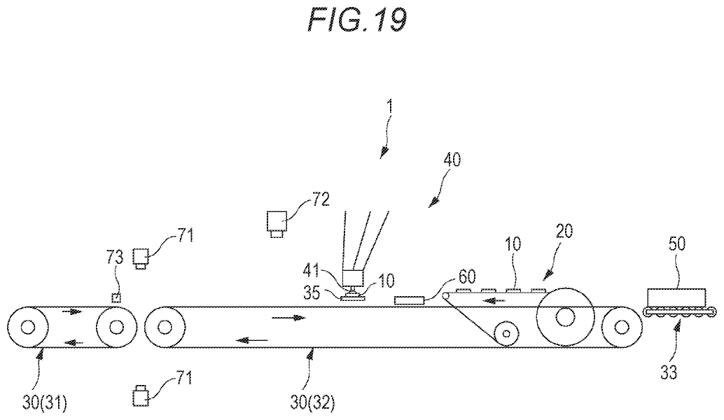

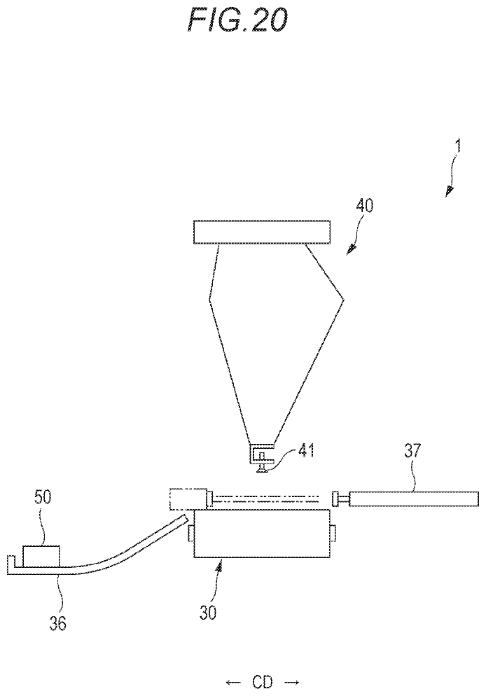

In writing to the electronic tag 10, a writing error may occur. In this case, since the objects 50 are being conveyed at the writing error detecting timing, it is preferable that in the case of timing at which writing can be re-executed in time, conveyance continues, or in the case of timing at which writing cannot be re-executed in time, conveyance is temporarily stopped and re-execution of writing is performed as illustrated in the flow of FIG. 24. However, in a method in which the electronic tag 10 received by the robot 40 is made to approach the writing device 60 by the robot 40 and writing is performed as in the illustrated example, when the writing error of the electronic tag 10 occurs, the subsequent process cannot be performed before detaching the electronic tag 10. Here, as illustrated in FIG. 11 and the like, a temporary sticking part 35 to which the electronic tag 10 to be discarded is stuck is installed in a space other than a conveyance space of the objects 50 by the conveyor 30, and when the writing error of the electronic tag 10 occurs, as illustrated in FIG. 19, it is preferable that the control unit 90 controls such that the electronic tag 10 received by the robot 40 is stuck to the temporary sticking part 35, and an object 50 to which the electronic tag 10 is scheduled to be stuck is discharged from the conveyor 30 without sticking the electronic tag 10 thereto. In the case of discharging the object 50 from the conveyor 30, the object 50 can be discharged in a similar manner as in a normal operation as illustrated in FIG. 19. In addition to this, as illustrated in FIG. 20, it is also possible to install an inferior good discharge unit 36 such as a discharge chute, and an extrusion device 37 such as an air cylinder that pushes the object 50 on the conveyor 30 to the inferior good discharge unit 36 on a lateral side of the conveyor. In addition, the writing error of the electronic tag 10 occurs repeatedly, the writing error is not solved by re-execution of writing in many cases. Therefore, as illustrated in the flow of FIG. 24, the control unit 90 can count the writing error, and can stop at least the conveyor 30 when the error repetitively occurs a predetermined number of times. In this case, of course, the entirety of the system 1 may be temporarily stopped.

When reading out the designated sticking position, a designated sticking position read-out error may occur due to an image recognition error, or non-storage of an image of the objects 50 and the designated sticking position in the storage unit 80. In this case, the robot 40 cannot stick the electronic tag 10 that is received already to the object 50. Further, as described above, when the electronic tag 10 is conveyed to the robot 40 and writing is terminated before reading-out of the designated sticking position is completed due to a high speed in processing, the subsequent process cannot be performed before detaching the electronic tag 10. Here, it is preferable that the temporary sticking part 35 is installed, and when the designated sticking position is not read out until the objects 50 pass through the sticking possible range of the robot 40 after detecting the individual information by the individual information sensor 71, it is regarded as a designated sticking position read-out error, the electronic tag 10 received by the robot 40 is stuck to the temporary sticking part 35, and an object 50 to which the electronic tag 10 is scheduled to be stuck is discharged from the conveyor 30 without sticking the electronic tag 10 thereto as in the case of the above-described writing error of the electronic tag 10.

Here, description of “until the objects 50 pass through the sticking possible range of the robot 40 after detecting the individual information by the individual information sensor 71” can be sensed by passage of time from detection of the objects 50 by a sensor (as the sensor, a dedicated sensor may be installed in addition to use of the above-described passage sensor 73 or the individual information sensor 71) configured to detect the objects 50 which is located upstream of the imaging device 72. Of course, the passage sensor 73 may be installed downstream of the imaging device 72, and on the basis of the detection result, the timing at which the objects 50 pass through the sticking possible range of the robot 40 may be sensed.

As another example, when continuous processing on the same objects 50 is selected by the input device 81, the following configuration is also suggested. Specifically, when sticking the electronic tag 10 to the first object 50, the control unit 90 causes the writing device 60 to write writing information including at least one of a part or the entirety of individual information detected by the individual information sensor 71 and the association information acquired on the basis of the detected individual information to the electronic tag 10 to be stuck to the object 50 for which detection of the individual information is performed. When sticking the electronic tag 10 to the same objects 50 after the first object 50, the control unit 90 causes the writing device 60 to write the writing information in the first object 50 to the electronic tag 10 to be stuck to the objects 50 after the first object 50. In this case, when a worker selects the continuous processing by using the input device 81, a plurality of the same objects 50 can be continuously processed while the selection is valid. Accordingly, in the case of processing a certain number of objects 50, information writing to the electronic tag 10 and sticking can be effectively performed (semi-automatically). In addition, in comparison to the case of automatically recognizing products, control becomes simple and there is no concern of erroneous recognition of the objects 50.

### Industrial Applicability

The invention can be used to write information relating to objects to an electronic tag when attaching the electronic tag to objects such as products.

### REFERENCE SIGNS LIST

1 Electronic tag writing system
10 Electronic tag
10a, 10i Inlet
10a Antenna
10i IC chip
11 Adhesive surface
12 Non-adhesive portion
13 Residual adhesive portion
15 Electronic tag sheet
16 Release sheet
20 Tag supply unit
21 First belt conveyor
21B First belt
23G Folding-back guide
23R Electronic tag roll
23W Winding shaft
30, 40 Sticking unit
30 Conveyor
31 First conveyor
32 Second conveyor
33 Free roller conveyor
35 Temporary sticking part
36 Inferior good discharge unit
37 Extrusion device
40 Robot
41 Suction unit
50 Object
51 Individual information
60 Writing device
70 Information acquisition unit
71 Individual information sensor
71L Lower sensor
71U Upper sensor
72 Imaging device
73 Passage sensor
80 Storage unit
81 Input device
82 Display device
90 Control unit
E1 First device
E2 Second device
E0 One device
E3 Third device
P1 First process
P2 Second process
P3 Third process

1-6. (canceled)

7. An electronic tag writing system comprising:
a writing device that writes writing information to an electronic tag; and
an information acquisition unit that reads out the writing information and a processing order from a storage unit that stores the writing information and the processing order in association with each other, the writing information and the processing order relating to objects associated with the electronic tag,
wherein the writing information associated with the processing order is written to the electronic tag by the writing device in accordance with the processing order acquired by the information acquisition unit.

8. The electronic tag writing system according to claim 7,
wherein in a production and distribution process of the objects, the processing order of the objects in the process and the writing information of each of the objects are stored in the storage unit.

9. The electronic tag writing system according to claim 8, further comprising:
a tag supply unit that sequentially supplies the electronic tag to the writing device,
wherein in a first process in the production and distribution of the objects, the processing order of the objects in the process, and the writing information of each of the objects are acquired and are stored in the storage unit, and
in a second process of processing the objects in the processing order downstream of the first process, the writing information associated with the processing order is sequentially written to the electronic tag by the writing device in accordance with the processing order.

10. The electronic tag writing system according to claim 8, further comprising:
a tag supply unit that sequentially supplies the electronic tag; and
a tag attachment unit that attaches the electronic tag supplied from the tag supply unit to the object,
wherein in a first process in the production and distribution of the objects, the processing order of the objects in the process, and the writing information of each of the objects are acquired and are stored in the storage unit,
in a second process in the production and distribution of the objects, the electronic tag is attached to the objects by the tag attachment unit, and
in a third process of processing the objects in the processing order downstream of the first process and the second process, the writing information associated with the processing order is sequentially written to the electronic tag attached to the objects by the writing device in accordance with the processing order.

11. The electronic tag writing system according to claim 8,
wherein a supply unit of the electronic tag and an attachment unit of the electronic tag are not provided, and
in a process of processing the objects in the processing order in the production and distribution of the objects, the writing information associated with the processing order is written to the electronic tag attached to the objects by the writing device in accordance with the processing order acquired by the information acquisition unit.

12. A method of writing an electronic tag, comprising:
reading out writing information and a processing order from a storage unit that stores the writing information and the processing order in association with each other, the writing information and the processing order relating to objects associated with the electronic tag; and
writing the writing information associated with the processing order to the electronic tag in accordance with the read-out processing order.
